(19) United States
(12) Patent Application Publication
(10) Pub. No.: US 2006/0236819 A1
(43) Pub. Date: Oct. 26, 2006

(54) Pawl structure of a ratchet wrench

(76) Inventor: Chang Chuan Lee, Tiachung (TW)

Correspondence Address: Lee Chang Chuan, P.O. Box 2103, Taichung, TW

(21) Appl. No.: 11/147,201

(22) Filed: Jun. 8, 2005

(30) Foreign Application Priority Data
Apr. 20, 2005 (TW) 094206209

(51) Int. Cl. B25B 13/46

(52) U.S. Cl. 81/63.1

(57) ABSTRACT

A pawl structure of a ratchet wrench, including a wrench main body, a pawl assembly and a ratchet wheel. The wrench main body includes a wrench handle and a head section. The head section is formed with a first receiving cavity in which the ratchet wheel is accommodated. An outer circumference of the ratchet is formed with multiple ratchets. The ratchet wheel is retained in the first receiving cavity by a C-shaped retainer ring. A pawl cave is formed on a circumferential wall of the first receiving cavity for receiving the pawl assembly therein. The pawl assembly includes a first and a second pawls and a resilient member. Each pawl is formed with ratchets facing the ratchet wheel. Two adjacent opposite sides of the pawls are respectively formed with a first projecting post and a second projecting post. Two ends of the resilient member are respectively fitted on the first and second projecting posts, whereby the resilient member is interconnected between the first and second pawls. The pawls are engageable with the ratchets of the ratchet wheel for driving the ratchet wheel.

### BACKGROUND OF THE INVENTION

The present invention is related to a pawl structure of a ratchet wrench, and more particularly to a pawl structure free from direction switching button.

Taiwanese Patent Publication No. M240307 discloses a wrench structure. The wrench has a wrench handle with a driving head end. The driving head end is formed with a driving receiving cavity and a direction control cavity. An uninterrupted partition section is formed between the driving receiving cavity and a direction control cavity. In addition, a guide slot is formed between the driving receiving cavity and a direction control cavity. A direction block is received in the guide slot. An activation slot communicates the guide slot with the direction control cavity. The activation slot is open to the driving receiving cavity. A bottom edge of the partition section is formed with an escape slot, whereby the direction block can be directly placed from the driving receiving cavity into the guide slot. The bottom edge is further formed with a structure extending through the activation slot into the direction control cavity to be driven by a direction control member. The direction block can be quickly and conveniently installed. In addition, the strength of the driving head end of the wrench handle is enhanced.

However, the above wrench structure still has some shortcomings as follows:

1. The direction control member has a complicated structure and is hard to manufacture. Therefore, the cost for such wrench is relatively high.

2. The direction control member has a complicated structure and is hard to assemble.

### SUMMARY OF THE INVENTION

It is therefore a primary object of the present invention to provide a pawl structure of a ratchet wrench, including a pawl assembly. The pawl assembly includes a first and a second pawls which can be engaged with the ratchets of the ratchet wheel in reverse directions to one-way drive the ratchet wheel. Therefore, the pawl structure of the ratchet wrench is simplified. In addition, the first and second pawls are both positioned in the pawl cave and can be easily assembled/disassembled and located.

According to the above object, the pawl structure of the ratchet wrench of the present invention includes a wrench main body, a pawl assembly and a ratchet wheel.

The wrench main body includes a wrench handle and a head sect ion. The head section is formed with a first receiving cavity in which the ratchet wheel is accommodated. An outer circumference of the ratchet is formed with multiple ratchets. The ratchet wheel is retained in the first receiving cavity by a C-shaped retainer ring. A pawl cave is formed on a circumferential wall of the first receiving cavity for receiving the pawl assembly therein.

The present invention can be best understood through the following description and accompanying drawings wherein:

### BRIEF DESCRIPTION OF THE DRAWINGS

FIG. 1 is a perspective exploded view of the present invention;

FIG. 2 is a sectional view showing the operation of the present invention in one state; and

FIG. 3 is a sectional view showing the operation of the present invention in another state.

### DETAILED DESCRIPTION OF THE PREFERRED EMBODIMENTS

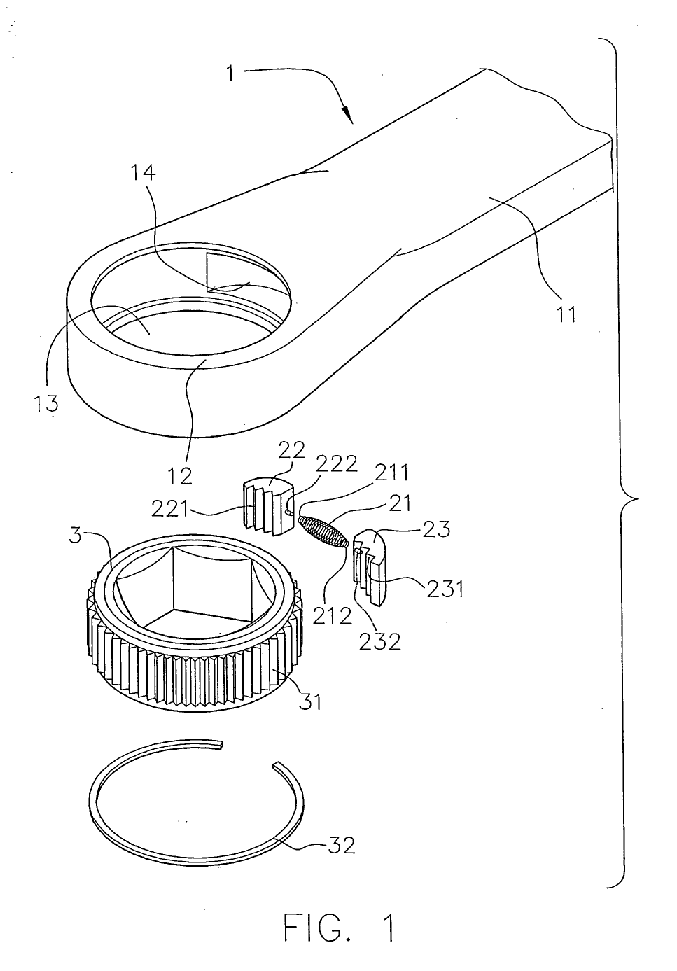

Please refer to FIGS. 1 to 3. The pawl structure of the ratchet wrench of the present invention includes a wrench main body 1, a pawl assembly 2 and a ratchet wheel 3.

The wrench main body 1 includes a wrench handle 11 and a head section 12. The head section 12 is formed with a first receiving cavity 13 in which the ratchet wheel 3 is accommodated. In this embodiment, the outer circumference of the ratchet 3 is formed with multiple ratchets 31. The ratchet wheel 3 is retained in the first receiving cavity 13 by a C-shaped retainer ring 32. A pawl cave 14 is formed on the circumferential wall of the first receiving cavity 13. The pawl cave 14 extends to the wrench handle 11 for receiving the pawl assembly 2 therein. In this embodiment, the pawl assembly 2 includes a first and a second pawls 22, 23 and a resilient member 21. Each pawl 22, 23 is formed with ratchets 221, 231 facing the ratchet wheel 3. Two adjacent opposite sides of the pawls 221, 231 are respectively formed with a first projecting post 222 and a second projecting post 232. Two ends of the resilient member 21 are respectively fitted on the first and second projecting posts 222, 232, whereby the resilient member 21 is interconnected between the first and second pawls 22, 23. The ratchets 221, 231 of the pawls 22, 23 are engageable with the ratchets 31 of the ratchet wheel 3 for driving the ratchet wheel 3.

When assembled, the resilient member 21 is fitted on the first and second projecting posts 222, 232 and interconnected between the first and second pawls 22, 23 to form the pawl assembly 2. The pawl assembly 2 is installed into the pawl cave 14 with the ratchets 221, 231 of the pawls 22, 23 facing the ratchets 31 of the ratchet wheel 3. Then the C-shaped retainer ring 32 is mounted into the first receiving cavity 13 to form a one-way ratchet mechanism.

The first and second pawls 22, 23 are both positioned in the pawl cave 14 and can be easily assembled/disassembled and located.

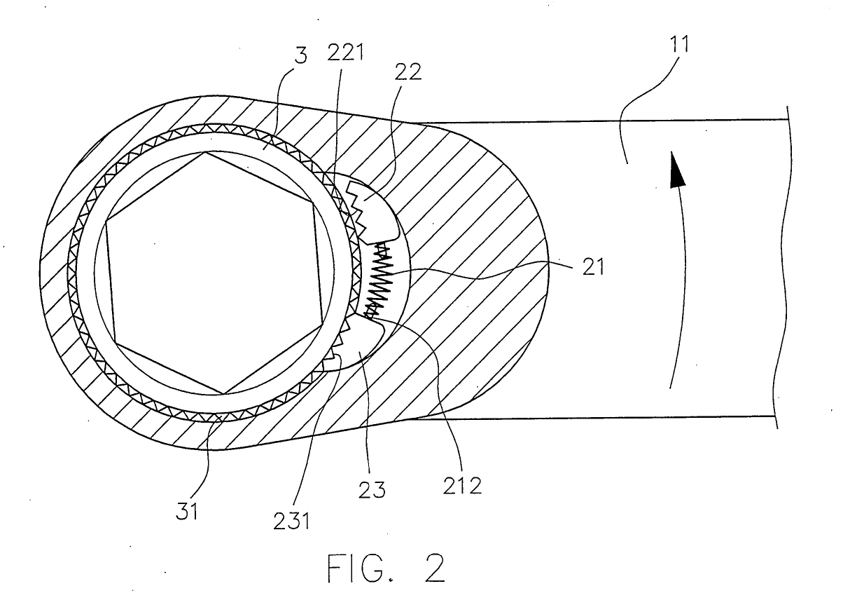

In use, as shown in FIG. 2, when the wrench handle 11 is counterclockwise wrenched, the second pawl 23 is pushed by the resilient member 21, whereby the ratchets 231 of the second pawl 23 are engaged with the ratchets 31 of the ratchet wheel 3 for wrenching a work piece.

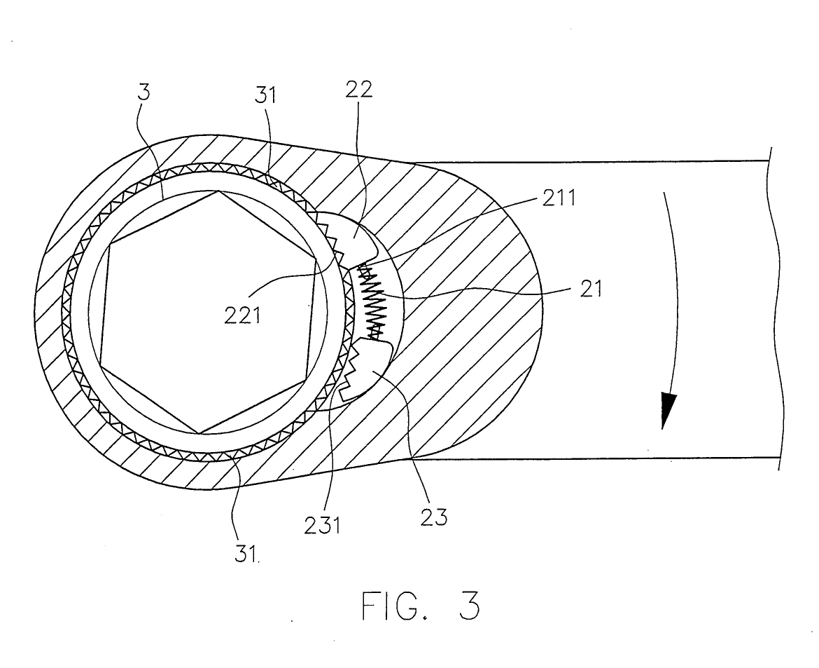

Reversely, as shown in FIG. 3, when the wrench handle 11 is clockwise wrenched, the first pawl 22 is pushed by the resilient member 21, whereby the ratchets 221 of the first pawl 22 are engaged with the ratchets 31 of the ratchet wheel 3 for wrenching a work piece.

The ratchets 221, 231 of the first and second pawls 22, 23 have the same profile so that the manufacturing of the pawls is simplified. As a result, the manufacturing cost is lowered. In addition, the ratchet wrench has simplified structure so that the pawl assembly 2 can be more conveniently assembled.

The above embodiments are only used to illustrate the present invention, not intended to limit the scope thereof. Many modifications of the above embodiments can be made without departing from the spirit of the present invention.

What is claimed is:

1. A pawl structure of a ratchet wrench, comprising a wrench main body, a pawl assembly and a ratchet wheel, the wrench main body including a wrench handle and a head section, the head section being formed with a first receiving cavity in which the ratchet wheel is accommodated, an outer circumference of the ratchet being formed with multiple ratchets, the ratchet wheel being retained in the first receiving cavity by a C-shaped retainer ring, a pawl cave being formed on a circumferential wall of the first receiving cavity, the pawl cave extending to the wrench handle for receiving the pawl assembly therein, the pawl assembly including a first and a second pawls and a resilient member, each pawl being formed with ratchets facing the ratchet wheel, two adjacent opposite sides of the pawls being respectively formed with a first projecting post and a second projecting post, two ends of the resilient member being respectively fitted on the first and second projecting posts, whereby the resilient member is interconnected between the first and second pawls, the ratchets of the pawls being engageable with the ratchets of the ratchet wheel for driving the ratchet wheel.
